(19) United States
(12) Patent Application Publication
(10) Pub. No.: US 2024/0318027 A1
(43) Pub. Date: Sep. 26, 2024

(54) ANTI-FOG COATINGS AND METHOD OF USING THE SAME

(71) Applicant: actnano, Inc., Boston, MA (US)

(72) Inventors: Peter KIM-SANTOS, Somerville, MA (US); Kayla KILDUFF, Somerville, MA (US); Reyhaneh TOUFANIAN, Medford, MA (US); Justin KLEINGARTNER, Boston, MA (US)

(73) Assignee: actnano, Inc., Boston, MA (US)

(21) Appl. No.: 18/358,324

(22) Filed: Jul. 25, 2023

Related U.S. Application Data
(60) Provisional application No. 63/491,566, filed on Mar. 22, 2023.

(51) Int. Cl. C09D 133/14; C09D 5/00; C09D 7/45; C09D 7/48; C09D 7/63; C09D 7/65

(52) U.S. Cl. CPC C09D 133/14; C09D 5/00; C09D 7/45; C09D 7/48; C09D 7/63; C09D 7/65

(57) ABSTRACT

An anti-fog coating composition to form a crosslinked film comprising a prepolymer and at least one amine bearing crosslinker is disclosed. The prepolymer comprises one or more charged monomer residues, one or more hydrophilic uncharged monomer residues, and one or more amine reactive monomer residues. The crosslinked film has a change in haze value of less than 30% when exposed to fog conditions for a period longer than 30 seconds. A kit comprising a first compartment comprising the prepolymer and a second compartment comprising the amine bearing crosslinker is also disclosed. The anti-fog film and a coated article comprising the anti-fog coating are also described herein. A method of making anti-fog coated substrate by applying the composition thereto is also disclosed.

### CROSS REFERENCE TO RELATED APPLICATION

This application claims the benefit of priority to U.S. Provisional Application No. 63/491,566, filed on Mar. 22, 2023, the contents of which are incorporated herein by reference in its entirety.

### TECHNICAL FIELD

The present disclosure generally relates to anti-fog coatings and methods of making the same. Embodiments of the present disclosure also relate to compositions and kits used to make such coatings, as well as to films and coatings comprising such compositions that can be applied to desired substrates that benefit from optically transparent, anti-fog coatings, such as automotive windshields, camera lenses, and freezer windows.

### BACKGROUND

Anti-fogging coatings are commonly used to keep glass or other transparent substrates from becoming clouded by water condensation. A fogging environment occurs when the temperature of a surface is below the ambient dew point, which allows for water vapor to condense on the surface, forming droplets. The size and shape of these water droplets cause them to scatter light, which can reduce the optical clarity of the surface. Some prior inventions focus on applying a hydrophobic coating, such as silicone, to a substrate. These materials can work for a short duration, but they can be overwhelmed by aggressively fogging environments, resulting in a larger number of droplet nuclei forming on the surface. A more common strategy is using a hydrophilic coating so that water droplets possess a low contact angle with the coated substrate, which leads to the water forming transparent, flat sheets.

Hydrophilic coatings face a tradeoff between efficacy and durability. In a fogging environment, hydrophilic coatings remain clear by favorably interacting with liquid water, which results in a low contact angle that causes liquid water to form a flat film across the coating. However, due to these coatings' strong interaction with liquid water, they may be easily washed away, or they may swell in the presence of liquid water or water vapor, becoming susceptible to damage. Conversely, more mechanically durable coatings incorporate stronger intermolecular connections within the coating, such as chemical crosslinks or hydrophobic interactions, but this can diminish the hydrophilicity of the coating and reduce performance.

Although there are a variety of “permanent anti-fog coatings” available in the market, they mostly consist of crosslinked hydrophilic polymers. At least one common disadvantage of these permanent anti-fog coatings is that they may be toxic or otherwise contain hazardous ingredients. For example, to make anti-fog coatings using crosslinked hydrophilic polymers, hazardous reagents, such as aziridine crosslinkers, isocyanate functional materials, or tin catalysts are often required. Such hazardous reagents have major toxicity and environmental concerns; therefore, they are heavily regulated and difficult to safely use in industrial settings.

Other common disadvantages of anti-fog coatings made from crosslinked hydrophilic polymers is that they can be difficult to apply on a surface, or they may have poor mechanical properties upon application to the substrate. For example, coating compositions that rely upon crosslinking may develop high viscosities over time as the crosslinker and polymer react. As a result of this, it can be difficult to apply the coating composition on the surface of a substrate. For another example, other anti-fog coatings may use blocked crosslinkers that require extended thermal processing to form a coating on an article or the final product. If insufficient thermal treatment is applied, the coating may not continue curing to a sufficient level under ambient conditions. The necessity of extended thermal processing can be difficult for the application.

Furthermore, another drawback for most of the commercially available anti-fog coating compositions is that they lack the combination of desirable features of coatings for practical application, such as long pot life and fast curing capacity at room temperature. Curing is an important process step, which can maximize a coated substrate's desired properties by ensuring proper adhesion, mechanical strength, chemical resistance and beneficial surface properties of the coating. For example, curing may prevent a coating from being washed away by water or other solvents, it may increase the hardness or modulus of the coating, or surface-active additives may assemble at the surface of the coating during curing to lower friction at the surface. If the coating is unable to cure at room temperature, careful process controls are necessary to ensure complete curing. Coatings that cure at room temperature avoid this risk because any incomplete curing reactions can continue after the initial application process is finished.

Pot life is another important property of any coating formulation; generally longer pot life corresponds to a longer process window to apply the coating composition in an industrial setting. Coatings with too short of a pot life can damage application equipment by irreversibly curing inside valves, tubing, or other parts. In general, faster curing of a coating composition at room temperature corresponds to a shorter pot life, which results in a tradeoff between two important criteria for coating application. Balancing a time efficient curing process while maintaining acceptable pot life of the coating composition is a challenge for both coating manufacturers and users.

Another challenge associated with applying anti-fog coating compositions on substrates or making anti-fog coatings using crosslinked hydrophilic polymers is that most of the polymer crosslinking reactions are highly sensitive to environmental conditions (e.g., temperature, pressure, UV light, humidity, or the presence of other chemicals). Therefore, it is necessary to have a highly controlled environment for industrial applications of such coatings.

Another disadvantage of many anti-fog coatings is that they rely on “sol-gel” chemistry and require a complex coating technique. The process involves the conversion of monomers into a colloidal solution (sol) that acts as the precursor for an integrated network (or gel) of either discrete particles or network polymers. For example, the sol-gel process may include water-catalyzed hydrolysis and condensation of alkoxy-silane groups. Although commonly utilized, the sol-gel process itself, and the chemistry of the reactants for the process can make the implementation of the sol-gel technique challenging in an industrial setting. The sensitivity of the precursors to water can complicate the storage of the precursors prior to their use. For example, instead of using water, it might be necessary to use a flammable solvent with a high volatile organic compound (VOC) content as a carrier to store the precursors. The complex nature of the hydrolysis and condensation may require careful control over the application conditions and can often put limits on the usable lifetime of the coating (the “pot life”) before it gels, making it no longer useful to apply as a film and potentially causing damage to application machinery. Furthermore, the final properties of such anti-fog coatings prepared using the sol-gel process can be affected by the curing protocol, and therefore, careful process control is necessary to produce crack-free and sufficiently durable coatings.

Furthermore, anti-fog coatings made from crosslinked hydrophilic polymers may exhibit “fouling” behavior which refers to contamination from hydrophobic molecules sticking to the surface of the coated substrate. Fouling is undesirable when coating any substrate as the accumulation of unwanted materials on the substrate may occur. To make coatings “fouling-resistant”, often additional chemicals are needed. For example, silicone or fluoropolymers are commonly used to provide anti-fog coatings with low surface energy and low-friction properties.

The disclosed anti-fogging crosslinked coating compositions are directed to overcoming one or more of the problems set forth above and/or other problems of the prior art. In particular, the coating compositions disclosed herein have a high fogging resistance over time. In addition, when the composition is made into a coating it is mechanically durable, and not easily scratched, damaged, or fouled during use. Finally, in some embodiments, the coating can be applied from a compound with a long pot life, or a composition, or a kit comprising the compound or composition which makes the industrial application of the coating versatile and easy to use.

Furthermore, the disclosed anti-fogging crosslinked polymeric coating compositions do not use highly toxic crosslinkers that may necessitate expensive safety protocols. The disclosed coating is capable of curing at room temperature and can be applied on versatile types of substrates irrespective of substrate chemistry. The method of applying the disclosed coating composition on a substrate is simple and can be used to make anti-fog coatings on a variety of substrates while ensuring sufficient curing of the coating with fewer expensive process controls compared to the available anti-fog coatings in the market. Another advantage of the disclosed coating composition or kit is that they have a long pot life, greater than 24 hours, which allows for easier implementation, less material waste and limits the risk of a coating seizing up and damaging application machinery. The disclosed composition or kit can be stored completely or partly in water as a carrier which reduces VOC emissions and flammability concerns and therefore is less toxic and more environmentally friendly. Finally, the disclosed coating provides strong and long-lasting anti-fogging properties to the substrate on which it is applied on.

The features and advantages of the compounds, compositions, kits, coatings, and methods disclosed herein are illustrated by the following examples, which are not to be construed as limiting the scope of the present disclosure in any way.

### SUMMARY

In view of the foregoing, in one embodiment, there is described a composition for forming a crosslinked film that imparts anti-fog properties. In some embodiments, the composition comprises a prepolymer comprising (a) one or more charged monomer residues, which may be hydrophilic (b) one or more hydrophilic uncharged monomer residues, and (c) one or more amine reactive monomer residues; and at least one amine bearing crosslinker. The described crosslinked film has a change in haze value of less than 30% when exposed to fog conditions for a period longer than 30 seconds.

In another embodiment, there is described an anti-fog film comprising a crosslinked polymer. In some embodiments, the crosslinked polymer comprises: (a) one or more charged monomer residues, which may be hydrophilic; (b) one or more hydrophilic uncharged monomer residues; (c) one or more amine reactive monomer residues; and (d) at least one amine bearing crosslinker residue. The described anti-fog film exhibits a change in haze values of less than 30% when exposed to fog conditions for a period longer than 30 seconds.

In another embodiment, there is described a coated article comprising: a substrate and a coating. In some embodiments, the coating comprises: a crosslinked polymer comprising (a) one or more charged monomer residues, which may be hydrophilic; (b) one or more uncharged monomer residues; (c) one or more amine reactive monomer residues; and (d) at least one amine bearing crosslinker residue, wherein the coated article exhibits a change in haze value of less than 30% when exposed to fog conditions for a period of time longer than 30 seconds.

In yet another embodiment, there is described a method of making a surface of a substrate resistant to fogging. In some embodiments, the described method comprises applying to the surface of the substrate a compound comprising: a first composition and a second composition. In some embodiments, the first composition is made from a prepolymer that comprises (a) one or more charged monomer residues, which may be hydrophilic; (b) one or more uncharged monomer residues; and (c) one or more amine reactive monomer residues. In some embodiments, the second composition comprises at least one amine bearing crosslinker. Once treated, the substrate exhibits a change in haze value of less than 30% when exposed to fog conditions for a period longer than 30 seconds.

In yet another embodiment, there is described a kit for forming a hydrophilic, crosslinked film. In some embodiments, the kit comprises: (A) a first component and (B) a second component, wherein the hydrophilic, crosslinked film exhibits a change in haze value of less than 30% when exposed to fog conditions for a period longer than 30 seconds. In some embodiments, the first component (A) comprises a first composition comprising a prepolymer. The prepolymer comprises (a) one or more charged monomer residues, which may be hydrophilic; (b) one or more uncharged monomer residues; and (c) one or more amine reactive monomer residues. In some embodiments, the second component (B) comprises a second composition comprising at least one amine bearing crosslinker.

As described in more detail below, the various embodiments may include at least one additive that aids in resulting properties of the composition, film, coated article or method, such as an additive that aids adhesion, anti-freeze, crosslinking, film-forming, mechanical or rheological properties.

### DETAILED DESCRIPTION OF THE INVENTION

### Definitions

As used herein, “Haze value” refers to a number representing the scattering of light due to inhomogenities or discontinuities in a material which could lead to unfavorable optical properties such as a reduction in clarity. A haze measurement device such as a haze meter can be used to measure this number. The term “A Haze” refers to the change in haze values or haze measurements performed according to ASTM D1003 from before and after steam exposure. For example, the haze value of a sample equilibrated at 25° C. was measured as per ASTM D1003. Then, the sample was held over a beaker of boiling water for 60 seconds and the haze value of the sample was evaluated again using ASTM D1003. The first measurement subtracted from the second measurement is defined as “A Haze.” In general, Haze value is measured as the percentage of incoming light scattered and has no specific unit and is expressed in percentage. Per the ASTM specification, a material having a Haze value greater than 30% is defined as “diffusing”, and thus can serve as a boundary between a sample that is optically clear versus one that is hazy or not optically clear.

As used herein, “monomer” refers to a chemical entity that can serve as the smallest repeating unit in a polymer and has one or more reactive chemical groups configured for polymerization. For example, methacrylates are monomers that can serve as repeating units in a methacrylate polymer (e.g., polymethylmethacrylate) and have a reactive alkene configured for polymerization.

As used herein, the term “hydrophilic monomer” refers to a monomer that has a high solubility in water. For example, a hydrophilic monomer may have a solubility of greater than 100 g/L in deionized water at room temperature.

As used herein, the term “charged monomer” refers to a monomer that has an atom or a molecule with an electrical charge when dissolved in deionized water. A charged monomer contains either a positive or negative charge. Non-limiting examples of such charged monomers include acrylic acid, or any salt formed by neutralizing acrylic acid with a base. In contrast, an “uncharged monomer” does not contain a charge when dissolved in deionized water.

As used herein, the term “amine reactive monomer” refers to a monomer that is capable of undergoing a chemical reaction with an amine functional group.

As used herein, the term “amine bearing monomer” refers to a monomer that has an amine functional group in its structure. Amine bearing monomers are often characterized in terms of their “active hydrogens”, which determine the number of additional bonds an amine can form. For example, a primary amine has two active hydrogens and a secondary amine has one active hydrogen.

As used herein, “monomer residue,” “crosslinker residue,” or “residue” refers to a molecule that has gone through a chemical process. For example, a residue refers to a monomer that has been incorporated into an oligomer, prepolymer, or polymer during a polymerization reaction. Specifically, the polymerization of methacrylate monomers generates a poly(methacrylic) polymer comprised of methacrylate residues. Additionally, any unreacted methacrylate monomers also constitute methacrylate residues. Furthermore, a functional group that is chemically transformed is also a residue. For example, the ester that is formed from the reaction of acrylic acid and methanol is an acrylic acid residue.

As used herein, “prepolymer” refers to a polymer or oligomer containing monomer residues, and the prepolymer is intended to undergo a subsequent chemical reaction or processing step, such as crosslinking.

As used herein, the term “crosslinker” refers to a molecule that can undergo multiple reactions to form bonds between multiple polymer chains. This may result in the molecule reacting with multiple polymer chains, or it may react once with a polymer chain before undergoing a second type of reaction that results in a crosslinked network.

As used herein, the term “crosslinking” refers to a chemical reaction where chemical bonds are formed between two or more polymer chains. It is the process of chemically joining two or more molecules to form a crosslinked network. Factors affecting crosslinking include concentration of the crosslinkers, for example, concentrations of amine reactive monomers and amine bearing crosslinkers, the reaction duration, temperature, pH, solvent composition, viscosity, and the steric hindrance caused by the presence of functional groups in the monomers and crosslinkers that engage in the crosslinking reaction. As used herein, the term “initiator” refers to a molecule that can start a polymerization reaction.

As used herein, the term “polymer functionality” refers to the presence of a chemical functional group in the monomer residues of the polymer, which is a motif or family of motifs of atoms. Functional polymers are macromolecules that have unique properties or uses. The specific polymer functionalities are often determined by the presence of chemical functional groups present in the polymer that are dissimilar to those of the backbone chains.

As used herein, the term “additive” refers to any chemical or material which is added to a system containing the disclosed composition, where the addition of the additive into the system modifies one or more properties of the composition.

As used herein, the term “mechanical additive” refers to any chemical or material which is added to a sample containing the disclosed composition, where the addition of the additive into the sample is configured to modify the mechanical properties of the composition.

As used herein, the term “fog” refers to water droplets on surfaces which decrease the optical clarity of the surface. On the contrary, a substrate coated with an anti-fog coating may absorb water vapor before it can condense on the surface, may absorb water droplets after they have formed, or may cause the droplets to evenly wet the surface to form a film of water that minimizes the decrease in optical clarity.

As used herein, the term “anti-fog film or coating” refers to a film or coating that is configured to make a substrate have higher fog-resistance when coated on the substrate relative to the same substrate at a bare or no film condition.

As used herein, the term “fog-resistant” surface refers to a surface that's optical clarity is not diminished when it is exposed to fogging conditions. One method this can be evaluated is via the change in the haze value of a substrate when it is exposed to fogging conditions. For opaque substrates, such as metals or colored plastics, “fog-resistance” is evaluated qualitatively. One method for evaluating if an opaque sample is fog-resistant is to hold it over steam before making a visual examination. If water droplets significantly change the appearance of the sample, then it is not fog-resistant. If the substrate can be clearly observed, then it is fog-resistant or has anti-fogging properties.

As used herein, the term “fogging conditions” refers to a combination of temperature and humidity that allow for water to condense on a surface. Fogging on a substrate is favored when the air is humid, and the substrate is cooler than the dew point.

As used herein, the term “hydrophilic coating” refers to a coating that has an equilibrium water contact angle less than 90 degrees.

As used herein, the term “pot life” refers to the amount of time after a compound of multiple reactive compositions is combined that the mixed compound can be used. After this period of time, the compound may be too viscous to apply, or the curing process may not yield acceptable properties in the final product. In some industrial use cases, the “pot life” is quantified as the amount of time it takes for a mixed compound's initial viscosity to quadruple at room temperature. For example, the pot life of a kit comprising two components with two different compositions can be defined as the time it requires for the viscosity of the mixture of the two compositions to quadruple at room temperature. For example, if the compound formed after mixing two compositions of two compartments of a kit has an initial viscosity of 100 cP and the viscosity increases to 400 cP after 50 hours at room temperature, then the pot life is 50 hours at room temperature. The pot life of a compound can be modified by changing several parameters such as, by varying the solvent type or content.

As used herein, the term “curing” refers to the process of a composition undergoing a transformation where its mechanical and chemical properties are changed. Most typically, this entails a crosslinking reaction occurring, or chemical bonds being formed with a substrate.

### Composition

### Chemistry

In some embodiments, the disclosed coating composition may comprise a combination of polymers, prepolymers, solvents, additives, crosslinkers, and their residues.

In some embodiments, the disclosed coating composition may be a two-component (2K) system.

In some embodiments, the disclosed coating composition may require some charged molecules to be sufficiently hydrophilic.

In some embodiments, before application, a crosslinker or hardener may be mixed with the coating composition, which then cures on a substrate upon application.

In some embodiments, the disclosed coating composition may be hydrophilic. In other embodiments, the disclosed coating composition may be super-hydrophilic.

In some embodiments, the disclosed composition may not contain any catalysts or crosslinkers that are category 1 mutagens, or are listed as having category 1 acute toxicity, reproductive toxicity, or specific organ toxicity as defined by GHS.

In some embodiments, one or more solvents can be used in the disclosed composition. Non-limiting examples of such solvents include water, alcohols such as methanol, ethanol, isopropanol, n-butanol, t-butanol, sec-butanol, and 1-methoxy 2-propanol, amines like ammonium hydroxide or triethylamine, ethers or glycol-based solvents such as ethylene glycol, propylene glycol, glycerol, ketones such as acetone, ethyl acetate, or methyl ethyl ketone, or others that are appropriate for the polymers or prepolymers.

In some embodiments, the disclosed composition may contain one or more solvents in an amount that is sufficient to achieve the desired properties of the composition without imposing any severe acute toxicity or environmental concern.

In some embodiments, the disclosed composition may further comprise a catalytic acid or base to assist a crosslinking reaction between the prepolymer and the crosslinker.

### Compound

In some embodiments, the disclosed composition may be a two-component (2K) system comprising a first component and a second component. The first component may comprise the prepolymer and the second component may comprise the amine bearing crosslinker. In some embodiments, the first component and the second component may be found in the composition in an amount sufficient to form an anti-fog film having a change in haze values of less than 30% when exposed to fog conditions for a period longer than 30 seconds.

In some embodiments where the disclosed coating composition is a 2K system, the prepolymer in the first component may be dissolved, suspended, or dispersed in a carrier solvent or a liquid. The carrier solvent may be 20%-100% of water, and 0%-80% of a co-solvent or mixture of co-solvents that are water miscible. Non-limiting examples of such solvents or co-solvents may include methanol, ethanol, isopropanol, 1-methoxy 2-propanol, acetone, methyl ethyl ketone, ethyl acetate, butanol, ethylene glycol, propylene glycol, glycerol or any combinations thereof.

In some embodiments where the disclosed coating composition is a 2K system, the second component may comprise the amine bearing crosslinker or a mixture of crosslinkers. In some embodiments, the second component may comprise no solvents. In other embodiments, the amine bearing crosslinker or the mixture of crosslinkers may be dissolved in water in the second component. In yet some other embodiment, the second component may comprise the amine bearing crosslinker or the mixture of crosslinkers dissolved in a solvent or mixture of solvents that are water miscible. Non-limiting examples of such solvents include methanol, ethanol, isopropanol, 1-methoxy 2-propanol, acetone, methyl ethyl ketone, ethyl acetate, butanol, ethylene glycol, propylene glycol, glycerol or any combinations thereof.

In some embodiments where the disclosed coating composition is a 2K system, the first component may comprise a solution of 1-30 wt % prepolymer, 0.1-70 wt % water, 0.1-50 wt % alcohol, 0.001-2 wt % leveling additive, and 0.001-2 wt % UV stabilizer; wherein, the prepolymer may comprise 1-30 wt % charged monomer residues, 0.1-30 wt % amine reactive monomer residues, and 10-80 wt % uncharged monomer residues.

In some embodiments where the disclosed coating composition is a 2K system, the second component may comprise 1-99.9 wt % amine bearing crosslinker and 0.1-99 wt % water.

In some embodiments where the disclosed coating composition is a 2K system, the second component may comprise 1-80 wt % amine crosslinker, 0.1-90 wt % alcohol, and 0.1-25 wt % silane coupling agent.

### Prepolymer

In some embodiments, the composition comprises a prepolymer. In some embodiments, the composition may comprise a prepolymer synthesized using at least two or more hydrophilic monomers, at least a portion of which contains charged hydrophilic monomers.

In some embodiment, the prepolymer may comprise one or more monomer residues having residues of epoxy functionalities, unsaturated functionalities, azide functionalities, propargyl functionalities, acid anhydride functionalities, acid chloride functionalities, aldehyde functionalities, or isocyanate functionalities.

In some embodiment, the one or more charged monomer residues may comprise sulfonate, carboxyl, phosphonate, nitro, imidazolium, guanidinium, or quaternary ammonium functional groups, or monomers that can be converted into those functional groups including: 2-acrylamido-2-methylpropane sulfonic acid, [2-(methacryloyloxy)ethyl]dimethyl-(3-sulfopropyl)ammonium hydroxide, 2-ethyldimethylammonioethyl methacrylate, 2-(methacryloyloxy)ethyl] trimethylammonium, 4-styrenesulfonate, p-styrene carboxylic acid, vinyl sulfonic acid, 3-acrylamido-3-methylbutanoic acid, acrylic acid, methacrylic acid, 2-carboxyethyl acrylate, 1-allyl-3-methylimidazolium chloride, maleic anhydride, itaconic acid, 3-sulfopropyl acrylate, 11-phosphonoundecyl acrylate, vinylphosphonic acid, alginate methacrylate, 3-sulfopropyl methacrylate, 1-vinylimidazole, derivatives of these monomers, salts of these monomers, or combinations thereof.

In some embodiment, the one or more hydrophilic, uncharged monomer residues may comprise hydroxyl functional groups, pyrrolidone functional groups, acetate functional groups, or ether functional groups including: 2-hydroxyethyl methacrylate, hydroxypropyl methacrylate, n-vinyl-2-pyrrolidone, vinyl alcohol, N-(2-hydroxyethyl)methacrylamide, any acrylate or methacrylate-based monomer with a polyethylene glycol or polypropylene glycol functionality, vinyl acetate, diacetone acrylamide, tetrahydrofurfuryl acrylate or methacrylate, the acrylate or methacrylate of a carbohydrate, 2-ethoxyethyl methacrylate, diethylene glycol butyl ether methacrylate, derivatives of these monomers, or combinations thereof.

In some embodiments, the one or more charged monomer residues may be residues of monomers that have a solubility greater than 100 g/L in deionized water.

In some embodiments, the one or more charged monomer residues may be residues of monomers that are acidic, basic, or are the salt of a neutralized acid or base.

In some embodiments, the one or more hydrophilic, uncharged monomer residues may be residues of monomers that have a solubility greater than 100 g/L in deionized water.

In some embodiment, the one or more amine reactive monomer residues may comprise monomer residues bearing epoxy groups, ketone functional groups, anhydride functional groups, or isocyanate functional groups including: allyl methacrylate, vinyl methacrylate, glycidyl methacrylate, 2-isocyanatoethyl methacrylate, 3, 4-epoxycyclohexylmethyl methacrylate, methyl vinyl ketone, 4-vinyl-1-cyclohexene 1,2-epoxide, allyl glycidyl ether, diacetone acrylamide, n-hydroxy succinimide bearing monomers, maleic anhydride, residues of these monomers or functional groups, derivatives of these monomers, or combinations thereof.

### Crosslinker

In some embodiments, the disclosed coating composition may comprise an epoxy-amine crosslinker system.

In some embodiments, the composition may comprise an amine bearing crosslinker. The amine bearing crosslinker may be a Jeffamine or a hindered amine crosslinker. In some embodiments, the amine bearing crosslinker may be used for crosslinking the prepolymer to make the disclosed anti-fog coating composition.

In some embodiments, the amine bearing crosslinker may comprise primary amines or secondary amines that can form one or more covalent bonds with the polymer. Such amine bearing crosslinkers may include but are not limited to polyether amine, or a polymer with a polyether backbone comprising polyethylene oxide, polypropylene oxide, or other ethylene oxides that contains one or more nitrogen atoms per molecule, polyoxypropylenediamine, polyoxypropylenetriamine, O,O′-bis(2-aminopropyl) polypropylene glycol-block-polyethylene glycol-block-polypropylene glycol, or secondary amino silanes, such as n-butylaminopropyltrimethoxysilane, n-methylaminopropyltrimethoxysilane, bis(3-trimethoxysilylpropyl) amine, imidizoles, dicyandiamide, or any combinations thereof.

In some embodiments, the amine bearing crosslinker may aid in a longer pot life of the disclosed composition. The amine bearing crosslinker may be chemically hindered from participating in a crosslinking reaction, for example it may be designed to have steric hindrance near the amine functional groups, therefore, resulting in a slower rate of crosslinking reaction to produce the disclosed crosslinked film. Alternatively, the amine bearing crosslinker may be a secondary amine, therefore, resulting in a slower rate of crosslinking reaction to produce the disclosed crosslinked film. The composition may spontaneously cure on any substrate upon application. The slower rate of crosslinking of the disclosed composition may be useful for longer pot life and lower viscosity of the composition and therefore, easier applications.

### Additives

In some embodiments, the composition may further comprise at least one additive. The additive may be a mechanical additive, a coupling agent, a UV absorber, a UV stabilizer, a surfactant or leveling additive, dyes, biocides, or anti-freeze additives.

In some embodiments, the mechanical additive comprises one or more of silica nanoparticles, alumina nanoparticles, zinc nanoparticles, ceria nanoparticles, titania nanoparticles, cellulose nanofibers, polyhedral oligomeric silsesquioxanes (POSS) materials, silsesquioxane materials, silicone materials, fumed silica, polyamide particles, phyllosilicate particles, montmorillonite particles, boehmite particles, epoxy-bearing reactive dilutants, waxes, any dispersants or surface modification agents necessary to process the mechanical additives, or any combinations thereof.

In some embodiments, the silane coupling agent may comprise (3-aminopropyl)triethoxysilane, 2-(3,4-epoxycyclohexyl)ethyltriethoxysilane, (3-glycidoxypropyl)trimethoxysilane, 2-(3,4-epoxycyclohexyl)ethyltrimethoxysilane, (3-glycidoxypropyl)triethoxysilane, n-(2-aminoethyl)-3-aminopropyltrimethoxysilane, 3-mercaptopropyltrimethoxysilane, isocyanatopropyltriethoxysilane, n-methylaminopropyltrimethoxysilane, n-butylaminopropyltrimethoxysilane, bis(3-trimethoxysilylpropyl)amine, (3-triethoxysilyl)propylsuccinic anhydride, or any combinations thereof.

In some embodiments, the UV absorbers may comprise benzophenones, benzotriazoles, cyanoacrylates, hydroxyphenyl triazines, zinc nanoparticles, ceria nanoparticles, titania nanoparticles, or any combinations thereof.

In some embodiments, the UV stabilizers may comprise hindered amine light stabilizer (“HALS”) agents or other additives designed to prevent UV degradation including: bis (2,2,6,6-tetramethyl-4-piperidyl) sebacate, decanedioic acid, 1-methyl 10-(1,2,2,6,6-pentamethyl-4-piperidinyl), decanedioic acid, 1,10-bis(1,2,2,6,6-pentamethyl-4-piperidinyl)ester, dimethyl succinate polymer with 4-hydroxy-2,2,6,6-tetramethyl-1-piperidine ethanol, poly[[6-[(1,1,3,3,-tetramethylbutyl)amino-s-triazine-2,4-diyl] [2,2,6,6-tetramethyl-4-piperidyl)imino]]hexamethylene[(2,2,6,6-tetramethyl-4-piperidyl)imino]], or any combinations thereof.

In some embodiments, the surfactants, wetting agents, or leveling agents may comprise silicon polyether surfactants, polyethylene glycol p-(1,1,3,3-tetramethylbutyl)-phenyl ether, polysorbate based surfactants, sodium dodecyl sulfate, cetyltrimethylammonium bromide surfactants, dispersants, styrene-maleic acid copolymers, polyacrylates modified with silicones, polyethylene-polypropylene block copolymer surfactants, other commercially available leveling or wetting additives or any combinations thereof.

In some embodiments, the anti-freeze aid additive may comprise glycerol, ethylene glycol, propylene glycol, polypropylene glycol, or polyethylene glycol, or a molecule comprising at least one of the foregoing.

### Pot Life

In some embodiments, the composition may have a pot life of greater than 8 hours, such as 24 hours, such as greater than 48 hours, or greater than 72 hours, or greater than 96 hours at room temperature.

In some embodiments where the disclosed coating composition is a 2K system, the first component and the second component may be found in an amount sufficient for the composition to have a pot life greater than 8 hours, such as 24 hours, such as greater than 48 hours, or greater than 72 hours, or greater than 96 hours at room temperature after mixing the two components and being stored in a sealed container with a head space less than the volume of the composition.

In some embodiments, the composition may be applied as a single layer on a substrate.

In some embodiments, the composition may have a low viscosity of less than 1000 cP, such as less than 800 cP, such as less than 600 cP, such as less than 400 cP, such as less than 200 cP, such as less than 100 cP. In some embodiments, the composition may be easily sprayed on a substrate due to their low viscosity and long pot life.

### Film/Coating

In some embodiments, the disclosed coating may be water-absorbent. In some embodiments, the disclosed coating may have a low contact angle with water.

### Durability

In some embodiments, the coating composition may result in a film or coating that is stable (i.e., maintains its properties) after exposure to mechanical, chemical, or environmental stresses.

In some embodiments, the coating may have a high resistance to cleaning solvents. For example, the anti-fog coating can be rubbed with a cloth wet with cleaning solutions selected from those comprising 1%-100% isopropanol, 0.1%-10% sodium hypochlorite solution, 0.1%-5% ammonia, 0.1%-10% dish soap, and see a change in the A Haze value in the film of less than 2%.

In some embodiments, the coating may be soaked for 24 hours in deionized water, an aqueous solution of 5% NaCl, or an aqueous solution of 0.1% dish soap, and retain satisfactory mechanical and anti-fog properties.

In some embodiments, the coating can withstand mechanical abrasion. For instance, some embodiments can be rubbed using a linear abrader with a 1000 g load and a cheesecloth rubbing head for 1000 cycles and may exhibit a change in haze value of less than 5%, such as less than 2% and, in many cases, less than 1%. In another instance, an embodiment can be rubbed using a linear abrader with a 1000 g load and a sponge rubbing head for 1000 cycles and may exhibit a change in haze value of less than 5%, such as less than 2% and, in many cases, less than 1%.

In other embodiments, the coating can withstand rubbing with common household chemicals or cleaning supplies, including chemicals like “Windex”, “Formula 409”, “Armor All”, insect repellent, leather cleaner, sunscreen, and artificial perspiration. In these embodiments, a cloth can be wet with the chemical, and rubbed on the coating with a linear abrader under a 500 g applied load for 10 cycles. After cleaning away any chemical residue, the sample may exhibit a change in haze value of less than 5%, such as less than 2% and, in many cases, less than 1%. The sample may still exhibit anti-fogging properties after this testing.

In some embodiments, the coating may have excellent adhesion properties. The coating may be able to be tested according to the ASTM D3359 cross hatch adhesion test and receive a rating of 5B.

In some embodiments, the coating may have excellent humidity resistance properties. The coating may be exposed to 85° C., 95% relative humidity for 7 days, and not show any visual defects. The coating may retain excellent anti-fog properties, showing A Haze of less than 5%, such as less than 2% and, in many cases, less than 1% when tested according to a steam test. The coating may retain excellent adhesion properties after exposure to high temperature and humidity for 7 days, receiving a rating of 5B after testing according to the ASTM D3359 cross hatch adhesion test.

### Coated Article

In some embodiments, the substrate of a coated article may be glass, a plastic such as acrylic, polycarbonate, polyethylene terephthalate, poly(methyl methacrylate), poly(ethene-co-tetrafluoroethene), sheets of any of these polymer substrates with an adhesive backing, a metal such as aluminum, ceramic materials, or any combinations thereof.

In some embodiments, the substrate may include a layer that has been applied using a pretreatment step prior to the application of the anti-fog coating.

In some embodiments, the coated substrate or article may be an automotive or architectural structure, architectural windows, camera lenses, medical scope lenses, sensors, eyewear, mirrors, consumer electronic devices, personal protective equipment, other safety equipment, or refrigerator doors.

In some embodiments, the coated substrate or article may during exposure to fogging conditions exhibit a Δ Haze of less than 30%, such as less than 5%, or less than 2% and, in many cases, less than 1%. In some embodiments, a substrate coated with the coating composition according to the present disclosure, exhibits a Δ Haze ranging from 0.1% to less than 2%, such as 0.1% to 1.7%.

In some embodiments, the coating may provide hydrophilic properties to a substrate, but not necessarily for the purpose of making the substrate anti-fogging. For example, in some embodiments the coating may be applied to a metal substrate to increase its affinity for water, or it may be selectively applied to a metal substrate to direct water to the coated area and away from an uncoated area. In other embodiments the coating may be applied to a rubber substrate to allow water to more easily wet the surface. In yet other embodiments, the coating may be applied to marine surfaces to repel barnacles or other foulants.

In some embodiments the coating may be applied to surfaces to resist the formation of frost. In other embodiments, the coating may be applied to a substrate to increase the speed at which frost melts.

In some embodiments the coating of the coated article is in the form of a laminate. For example, in an embodiment, the laminate may comprise a transparent substrate, a clear adhesive, and coating. In an embodiment, the adhesive may be selected from acrylic adhesives, silicone adhesives, urethane heat-seal adhesives, polyethylene heat seal adhesives, and combinations thereof.

In some embodiments, the transparent substrate may comprise polyethylene, polyethylene terephthalate, polycarbonate, cellulose acetate, triacetal cellulose, polyacrylate, or combinations thereof.

In some embodiments, uncharged monomers, charged monomers, amine reactive monomers, or their residues may be incorporated during the crosslinking step.

In some embodiments the second composition comprising the crosslinkers also contains charged groups, and the charged groups can form chemical bonds with the prepolymer during curing.

In some embodiments, a prepolymer is prepared consisting of hydrophilic, uncharged monomer residues and amine reactive monomer residues.

In some embodiments, the first composition comprises commercial epoxy resins. In some embodiments, the epoxy resins are hydrophilic. In some embodiments, the epoxy resins comprise polyethylene glycol with epoxy functionalities, glycerol with epoxy functionalities, or sorbitol with epoxy functionalities. In other embodiments, these resins may instead bear vinyl, or other unsaturated functionalities.

In some embodiments, the second composition comprising the crosslinkers also comprises charged monomers that can bond with the amine reactive monomer residues. In some embodiments, these charged monomers have thiol functionalities. In some embodiments these charged monomers are 3-mercapto-1-propanesulfonate, cysteine, or salts or derivatives of these monomers.

Consistent with some embodiments described herein, the coating may have stronger mechanical properties.

### Method of Applying

In some embodiments, the coating composition may be applied on a glass substrate with or without adding a primer before the coating application.

In some embodiments, the surface may be pretreated, and/or primed before applying the coating composition.

In some embodiments, the coating composition may be applied on a substrate as a film-forming component.

In some embodiments, the coating composition may be applied on a substrate directly to bind to the surface.

In some embodiments, the method of applying the disclosed coating composition on the substrate may include washing the substrate with a surfactant, water, ethanol, isopropyl alcohol, or other cleaning solution prior to pretreatment.

In some embodiments, the method may comprise pretreating the substrate by exposing the substrate to corona or plasma treatment, ozone, UV-C, or another surface activating treatment prior to applying the coating composition.

In some embodiments, the method of applying the disclosed coating composition on the substrate may include applying the compound on the substrate by spray coating, needle dispensing, film coating, brush coating, roller, dip coating, or blade coating.

In some embodiments, the method may comprise thermally curing the compound after applying it on the substrate.

### Primer

In some embodiments, the method may comprise applying an undercoat of a compound on the substrate before applying the coating composition. The undercoat may comprise a primer or an adhesion promoter. In some embodiments, a silane coupling agent or primer may be applied on the substrate before applying the coating composition. This may aid in adhesion of the coating to the substrate.

In other embodiments, an undercoat that provides additional functionality to the coating system may be applied on the substrate before applying the coating composition depending on the properties of the substrate and properties of the coating to be achieved.

The primer may be a silane coupling agent that functionalizes the substrate with an amine, epoxy, thiol, amide, carboxylic acid, or isocyanate moiety. In some embodiments, the silane coupling agent may comprise (3-aminopropyl)triethoxysilane, 2-(3,4-epoxycyclohexyl)ethyltriethoxysilane, (3-glycidoxypropyl)trimethoxy silane, 2-(3,4-epoxycyclohexyl)ethyltrimethoxysilane, (3-glycidoxypropyl)triethoxysilane, n-(2-aminoethyl)-3-aminopropyltrimethoxysilane, 3-mercaptopropyltrimethoxysilane, isocyanatopropyltriethoxysilane, n-methylaminopropyltrimethoxysilane, n-butylaminopropyltrimethoxysilane, bis(3-trimethoxysilylpropyl)amine, (3-triethoxysilyl)propylsuccinic anhydride, or any combinations thereof.

In other embodiments, the primer may couple with the surface with a carboxyl group, a phosphonate group, or a catechol group. In other embodiments, the primer comprises dopamine or an amino acid.

In some embodiments, the substrate is pretreated with an undercoating, a layer of material between the substrate and the active top coating.

The undercoating may be a crosslinked polymer that when soaked in deionized water for one hour swells a smaller percentage of its dry thickness than the percentage the anti-fog coating swells of its dry thickness.

The undercoating may be applied by spraying, brushing, dipping, roller coating, or blade coating.

The undercoating may comprise epoxy functionalized molecule residues, an amine bearing crosslinker, a silane coupling agent, and at least one additive.

The epoxy functionalized molecule in the undercoating may comprise epoxy-functionalized polyethylene glycol, epoxy-functionalized glycerol, epoxy-functionalized sorbitol, or combinations thereof.

The amine bearing crosslinking in the undercoating may comprise a polyether amine, or a polymer with a polyether backbone comprising polyethylene oxide, polypropylene oxide, or other ethylene oxides that contains 1 to 4 nitrogen atoms per molecule, or secondary aminosilanes, such as n-butylaminopropyltrimethoxysilane, n-methylaminopropyltrimethoxysilane, bis(3-trimethoxysilylpropyl)amine, imidizoles, dicyandiamide, or any combinations thereof.

The silane coupling agent in the undercoating may comprise (3-aminopropyl)triethoxysilane, 2-(3,4-epoxycyclohexyl)ethyltriethoxysilane, (3-glycidoxypropyl)trimethoxysilane, 2-(3,4-epoxycyclohexyl)ethyltrimethoxysilane, (3-glycidoxypropyl)triethoxysilane, n-(2-aminoethyl)-3-aminopropyltrimethoxysilane, 3-mercaptopropyltrimethoxysilane, isocyanatopropyltriethoxysilane, n-methylaminopropyltrimethoxysilane, n-butylaminopropyltrimethoxysilane, bis(3-trimethoxysilylpropyl)amine, (3-triethoxysilyl)propylsuccinic anhydride, or any combinations thereof.

The at least one additive in the undercoating may comprise a mechanical additive, a coupling agent, UV absorbers, UV stabilizers, surfactants and leveling agents, dyes, or biocides.

In some embodiments, the method may comprise heating the substrate for 1-600 minutes at 30-150° C. after applying the composition.

In some embodiments, the method may comprise applying the compound on the substrate at 0.1-10,000 microns of wet thickness.

In some embodiments, the method may comprise applying the compound on the substrate at a dry thickness ranging from 0.001-100 microns.

In some embodiments, the method may be used to coat any substrate from automotive or architectural windows, camera lenses, medical scope lenses, sensors, eye wear, mirrors, consumer electronic devices, personal protective equipment, other safety equipment, refrigerator doors, or architectural structures with the disclosed coating composition.

### Curing Conditions

In some embodiments, the composition may form a hydrophilic coating that is dry to the touch after heating for 5 minutes at 130° C.

In some embodiments, the composition may form a hydrophilic coating that cures within 48 hours at 25° C. and 0%-50% relative humidity.

In some embodiments, where the disclosed composition is a 2K system, the first component and the second component may be found in the composition in an amount sufficient to form a hydrophilic coating that cures within 48 hours at 25° C. and 0%-50% relative humidity.

In some embodiments, where the disclosed composition is a 2K system, the first component and the second component may be found in the composition in an amount sufficient to form a hydrophilic coating that is dry to the touch after heating for 5 minutes at 130° C.

In some embodiments, the composition may cure at ambient room temperature conditions or elevated temperatures and humidity conditions when applied on a substrate. The curing of the composition may depend on several factors including the chemistry of the composition, thickness of the applied coating, the concentration of the crosslinker, for example, concentrations of amine reactive monomers and amine bearing crosslinkers and their relative ratios, the reaction duration, temperature, pH, solvent composition, viscosity, and the steric hindrance caused by the presence of functional groups in the monomers and crosslinkers that engage in crosslinking reaction.

In some embodiments, the composition when applied on a surface with crosslinker or hardener, may be cured in less than 10 minutes at a temperature above room temperature. Non-limiting temperatures include 100° C., 120° C., 130° C., or 150° C.

In some embodiments, the composition when applied on a surface with crosslinker or hardener, may be cured at room temperature.

In some embodiments, the composition when applied on a surface with crosslinker or hardener, may be cured such that it is dry to the touch in less than 2 minutes, with heating.

### Anti-Fog Property Measurement

In some embodiments, the disclosed anti-fog coating may be hydrophilic and have excellent fogging resistance and durability to chemical, mechanical, and environmental stresses. The hydrophilic coating may be capable of absorbing water vapor, causing the coating to swell instead of or prior to water droplets condensing on the substrate. Also, water droplets that are present on the surface may form a low equilibrium contact angle of less than 30° on a coated surface. As the coating swells, the contact angle may dynamically change with time. This property may cause the water droplets to form flat sheets on the surface and therefore may prevent optical distortion.

Depending on the humidity, temperature, and other environmental conditions, the anti-fog coating may provide anti-fog properties through the coating absorbing water and therefore, swelling of the coating; or the coating forming a low contact angle with water; or through performing both actions at the same time or successively. For example, when observed with naked eyes, a water droplet on a coated substrate with the disclosed anti-fogging coating may be seen as being absorbed in the coating, and therefore, leaving no liquid layer of water on the surface of the substrate, which may provide anti-fogging properties to the coated substrate at first. After exposure to a fogging environment such as being subject to steam exposure, the coating may become saturated with water and a film of water may form over the coating with a low contact angle.

Sometimes, this film of water may not be homogeneous while forming, and poor, transient optical properties can be briefly measured as the water is in the process of wetting the surface. For example, on a coating of uneven thickness, a water film may be inhomogeneous while forming, which may lead to poor, but transient, optical measurements. If a film of water has partially formed, evaluation of anti-fog properties should occur solely in an area where the film has completely formed, or after the water has fully wetted the surface.

An effective anti-fogging coating maintains high optical clarity in a fogging environment over time. This can be evaluated using visual observation, or quantitatively with methods such as measuring the haze value of films in a fogging environment via ASTM D1003 or measuring the degree of distortion of an image viewed through an anti-fog film following a modification of the standard EN-168.

In some embodiments, the anti-fog property evaluation may occur after the sample is soaked in deionized water for one hour, then allowed to rest for 24 hours at ambient conditions.

The features and advantages of the present invention are more fully shown by the following examples which are provided for purposes of illustration and are not to be construed as limiting the invention in any way.

### EXAMPLES

### Sample Preparation

Before coating, all glass substrates were cleaned by wiping with deionized water and isopropanol and then pretreated with corona discharge.

Before coating, all plastic substrates (e.g., polycarbonate, acrylic) were pretreated with corona discharge.

### Steam Test

A 250 mL Erlenmeyer flask was charged with 100 mL deionized water and brought to a boil. The haze value of a coated substrate was evaluated using a haze-meter according to ASTM D1003. The sample was then placed coating side down over the opening of the Erlenmeyer flask for a specified period of time. The sample was then removed from the flask and placed over the measurement port of the haze meter. Ten seconds after being removed from the flask, the haze value was measured and the A Haze was calculated by subtracting the measured haze value from the initially measured haze before steam exposure. Samples that showed a Δ Haze value above 30% were diffusing and were not anti-fogging. Samples that showed a Δ Haze below 30% provided anti-fogging properties. For some applications, A Haze values below 30% may be required for effective use in fogging environments. In these applications, A Haze less than 20%, less than 10%, less than 5%, less than 2%, or even less than 1% may be required for effective use.

### Modified EN-168 Test

Another technique for evaluating anti-fogging performance is through a modification of the EN-168 standard. This technique involves preparing a humid chamber according to the conditions specified in EN-168, with modifications to allow for image clarity analysis. At one side of the chamber, a Siemens star was installed as a visual target, opposite an opening in the chamber. A sample was placed over the opening with the anti-fogging coating facing the interior of the humid chamber. Images were taken every second for one minute or every minute for thirty minutes, and the modular transfer function was calculated using the NIH ImageJ image processing program and compared to the calculated modular transfer function of images taken under non-fogging conditions. The ratio of the integral of the modular transfer function at a set time point is compared to that of the initial measurement to generate a quantitative comparison over time.

### Polymer Definition

The abbreviations and compositions of the polymers used in the following examples are summarized below.

Prepolymer-1 consists of 21.4 wt % of the alkali salt of 2-acrylamido-2-methylpropane sulfonic acid, 70.8 wt % (hydroxyethyl)methacrylate, and 7.8 wt % glycidyl methacrylate.

Prepolymer-2 consists of 19 wt % of the alkali salt of 2-acrylamido-2-methylpropane sulfonic acid, 74.9 wt % (hydroxyethyl)methacrylate, and 6.1 wt % glycidyl methacrylate.

Prepolymer-3 consists of 20.4 wt % of the alkali salt of 2-acrylamido-2-methylpropane sulfonic acid, 71.7 wt % (hydroxyethyl)methacrylate, and 7.9 wt % glycidyl methacrylate.

### Example 1

### Preparation of Coating Composition

Solution S-1-1 was prepared with 11 wt % of prepolymer-1, 55.8 wt % water, 33 wt %1-methoxy-2-propanol, 0.1 wt % polyether siloxane copolymer, and 0.51 wt % bis (2,2,6,6-tetramethyl-4-piperidyl) sebacate. Solution S-1-2 consisting of 10 wt % polyoxypropylenetriamine and 90 wt % water was prepared. Solution S-1-3 consisting of 1 wt % (3-glycidyloxypropyl) trimethoxy silane in 99 wt % ethanol was then prepared.

### Application of the Coating Composition on a Substrate

Solution S-1-3 was sprayed onto the glass slide, and the wet glass slide was baked in an oven at 130° C. for 10 minutes. A mixture consisting of 4 g of the S-1-1, and 0.14 g of the S-1-2 was prepared. This mixture was then sprayed onto the glass slide and the wet glass slide was baked for 10 minutes at 130° C. This resulted in a coating on the glass slide.

### Thickness Measurement

The thickness of the coating on the glass slide was measured as 4.5 microns.

### Haze Measurement

The haze value (ASTM D1003) of the coating was measured as 0.2%. The glass slide with the coating was soaked in deionized water for 10 minutes and then rubbed or wiped dry with a cloth. The haze value of the glass slide with the coating was then measured as 0.3%, indicating the coating has cured with sufficient mechanical properties to withstand cleaning with water.

The change in haze value, A Haze of a coated glass slide prepared according to Example 1 was measured according to ASTM D1003 as a function of time. The experiment was performed according to the steam test procedure, but over thirty minutes.

TABLE 1
Time-dependent anti-fogging response of a coated
substrate prepared according to Example 1

| Time (minutes) | Δ Haze |
|---|---|
| 0 | — |
| 0.17 | −0.1 |
| 1 | 0 |
| 5 | 0.1 |
| 10 | 0.1 |
| 15 | 0 |
| 20 | 0.2 |
| 25 | 0.2 |
| 30 | 0.1 |

### Transmittance Measurement

The transmittance of the glass slide was then measured with a UV-Vis spectrophotometer. A blank glass slide was used as a control. The transmittance of the glass slide with the coating was above 99% relative to a glass slide blank between 400 nm and 700 nm.

### Exposure to Fog Conditions

The steam test was performed on the coating and a Δ Haze of 0.1% was measured. The glass slide with the coating was then soaked in deionized water for one hour. The glass slide with the coating was then dried and conditioned at room temperature for 24 hours. Then, the glass slide with the coating was affixed to a chamber designed according to EN-168 specifications and exposed to a humid atmosphere for 60 seconds. The glass slide with the coating did not fog within 60 seconds.

### Mechanical Strength Test

The glass slide with the coating was placed on a linear abrader and rubbed with cheesecloth under 1 kg of weight for 1000 cycles. After abrasion, the haze value of the glass slide with the coating was measured as 0.3%, and no damage was visible.

### Frost Testing

A sample was prepared in the same fashion as in Example 1, except tape was used to create a mask so that only one half of one face of the glass slide was coated. Then, this process was repeated on the opposite face of the glass slide and the tape was removed, resulting in a sample that was half-coated on both faces of the piece of glass.

The sample was chilled to −10° C., then removed and placed on a lab bench at ambient conditions, approximately 25° C. and 50% relative humidity. Frost formed on both faces of the uncoated half of the glass slide within seconds, resulting in poor optical clarity, and it was difficult to see through the glass slide. No frost formed on the coated half of the glass slide, and it was possible to clearly see through the sample. This indicates the coating is exceptional at mitigating frost formation and can be useful for applications that require good optical clarity at cold temperatures.

The sample was chilled to −40° C., then removed and placed on a lab bench at ambient conditions, approximately 25° C. and 50% relative humidity. Frost immediately formed over the entire sample within seconds. Within 10 seconds, frost could be observed dissipating from the coated half of the glass slide, while the uncoated glass slide remained covered in frost. Within 45 seconds, the frost was completely gone from the coated half of the sample, which appeared optically clear. On the uncoated half of the sample, the frost had just begun to melt at 45 seconds. After 2 minutes, a substantial amount of frost had melted on the uncoated half of the slide, but the residual water droplets made it difficult to see through that half of the slide. This indicates the coating is exceptional at anti-frost applications and can provide superior clarity in extremely cold environments.

### Pot Life Testing

A solution of S-4-3 was sprayed onto the glass slides and baked at 130° C. for 10 minutes.

A coating solution was prepared by mixing 12 g of solution S-1-1, and 0.42 g of solution S-4-2. The solution was aged for a predetermined amount of time. Then, the viscosity was measured, the coating sprayed onto one of the pretreated glass slides, and baked at 130° C. for 10 minutes. Coated slides were evaluated by visual appearance, haze measurement (ASTM D1003), and the steam test. After the three slides were coated, leftover coating solution was evaluated daily for gelling via an inversion test.

TABLE 2
Results from pot life testing of the coating described in Example 1

| Time | | | | Coated | Steam Test |
|---|---|---|---|---|---|
| Point | State of | Viscosity | Coated Slide | Slide Haze | Δ Haze |
| (h) | Matter | (cP) | Appearance | (%) | (%) |
| 0 | Liquid | 24 | Good | 0.3 | 0.1 |
| 8 | Liquid | 26 | Good | 0.5 | 0.2 |
| 24 | Liquid | 49 | Good | 0.3 | 0.2 |
| 72 | Liquid | — | — | — | — |
| 168 | Gel | — | — | — | — |

Application of the Coating Composition with Rapid Drying

A glass slide and a coating were prepared as described in Example 1. After being sprayed with coating, the glass slide was baked in an oven at 80° C. for 2 minutes to form a coating on the glass slide. The glass slide with the coating was then removed from the oven and touched with a finger. The coating on the glass slide was dry to the touch and was not damaged by handling.

### Polycarbonate Sheet as Substrate

A coating was prepared according to Example 1 and applied to a prepared polycarbonate sheet with an 80 microns bar coater. The wet polycarbonate sheet was then baked in an oven at 130° C. for 10 minutes to form a coating. The haze value of the polycarbonate sheet with coating was measured as 0.2%. The steam test gave a Δ Haze of 0.2%.

### Curing at Room Temperature

A coating was prepared according to Example 1 and applied to a pretreated polycarbonate sheet with an 80 microns bar coater to form a coating. The polycarbonate sheet with the coating was then allowed to rest at room temperature for 24 hours. The haze value of the polycarbonate sheet with the coating was measured as 0.6. The steam test gave a Δ Haze of 0.2%. The polycarbonate sheet with the coating was then rubbed with a wet cloth which did not show any evidence of damage, indicating the coating had sufficiently cured.

### Acrylic Sheet as Substrate

A coating was prepared according to Example 1, and the coating solution was applied via spray to a pretreated acrylic sheet. The wet acrylic sheet was baked at 80° C. for 10 minutes, then allowed to rest at room temperature for 24 hours to form a coating. The haze value of the acrylic sheet with the coating was measured as 0.2. The steam test gave a Δ Haze of 0.1%.

A sample of the coated acrylic sheet was mounted on a humidity chamber as described in ISO 6270 for 3 days. After which the sample was held over a beaker of 50° C. water for 1 minute, and no fogging was observed. A blank or uncoated acrylic sheet was used as a control. The control acrylic sheet was held over the beaker of 50° C. water, and the control acrylic sheet immediately became cloudy.

Another sample of the coated acrylic sheet was mounted on a humidity chamber as described in ISO 6270 for 10 days. After which the ASTM D3359 cross hatch adhesion tape test was performed and resulted in a rating of 5B. No coating was observed to be removed during the test.

### Example 2

### Preparation of Coating Composition

A solution S-2-1 was prepared with 11 wt % of prepolymer1, 55.8 wt % water, 33 wt %1-methoxy-2-propanol, 0.1 wt % polyether siloxane copolymer, and 0.51 wt % bis (2,2,6,6-tetramethyl-4-piperidyl) sebacate. A solution S-2-2 consisting of 10 wt % polyoxypropylenetriamine, 1.5 wt % bis(3-trimethoxysilylpropyl) amine, and 88.5 wt %1-methoxy-2-propanol was prepared. As a comparative example, a solution S-2-2* was prepared, identical to S-2-2, but without the 1.5 wt % bis(3-trimethoxysilylpropyl) amine.

### Application of the Coating Composition on a Substrate

A coating composition was prepared by mixing 4 g of S-2-1 with 0.14 g of S-2-2. Then, the coating composition was sprayed onto the cleaned glass slide and baked in an oven for 10 minutes at 130° C. to form a coating on the glass slide. This procedure was repeated with the comparative solution S-2-2* instead of S-2-2.

### Haze Value Measurement

The haze value of the glass slide with the coating was measured as 0.2%. The steam test gave a Δ Haze of 0.1%.

The glass slide with the coating was rubbed with a wet cloth, and no damage was visible with the naked eye, indicating that the coating had cured and bonded to the substrate with sufficient mechanical properties to be used without an additional primer. The comparative example using S-2-2* delaminated from the glass substrate when exposed to steam, or when rubbed with a wet cloth.

A coating was prepared according to the Example 2. An anodized aluminum substrate was cleaned with water and isopropanol and treated with corona discharge. The coating composition was brushed onto the aluminum substrate and baked for 10 minutes at 130° C. to form a coating. The aluminum with the coating was then rubbed with a wet cloth, and the coating remained adhered to the aluminum substrate.

### Example 3

### Preparation of Coating Composition

A solution S-3-1 was prepared with 11 wt % of prepolymer-1, 55.8 wt % water, 33 wt %1-methoxy-2-propanol, 0.1 wt % polyether siloxane copolymer, and 0.51 wt % bis (2,2,6,6-tetramethyl-4-piperidyl) sebacate. A solution S-3-2 consisting of 10% polyoxypropylenetriamine, and 90% water was prepared. A solution S-3-3 was prepared consisting of 1%3-mercaptopropyltrimethoxysilane in 99% ethanol.

### Application of the Coating Composition on a Substrate

Then, a solution of S-3-3 was sprayed onto the glass slide and baked in an oven at 130° C. for 10 minutes. Afterward, a coating composition was prepared by mixing with 4 g of the S-3-1 with 0.14 g of S-3-2 and allowed to stand for 10 minutes before spraying onto the glass slide and baking for 10 minutes at 130° C. to form a coating.

### Haze Value Measurement

The haze value of a glass slide with the coating was measured as 0.3%. The steam test gave a Δ Haze of 0.1%. The glass slide with the coating was rubbed with a wet cloth, and no damage was visible with naked eyes, indicating that this primer provides sufficient binding between the substrate and the coating.

### Example 4

### Preparation of Coating Composition

A solution S-4-1 was prepared with 16 wt % of prepolymer-2, 53.7 wt % water, 30 wt %1-methoxy-2-propanol, 0.05 wt % polyether siloxane copolymer, and 0.13 wt % bis (2,2,6,6-tetramethyl-4-piperidyl) sebacate. A solution S-4-2 consisting of 20 wt % O,O′-Bis(2-aminopropyl) polypropylene glycol-block-polyethylene glycol-block-polypropylene glycol, and 80 wt % water was prepared.

### Application of the Coating Composition on a Substrate

A coating composition was prepared by mixing with 0.9 g of S-4-1 with 0.05 g of S-4-2 and coated onto a pretreated sheet of polycarbonate with an 80 micron blade coater and baked for 10 minutes at 130° C. to form a coating.

### Haze Value Measurement

The initial haze of the sample was measured as 0.3%. The steam test gave a Δ Haze of 0.2%. The sample was evaluated using the modified EN-168 method.

TABLE 3
Time dependent anti-fogging response of a coated substrate
prepared according to Example 7, evaluated using the
EN-168 modular transfer function method.

| | Modular Transfer |
|---|---|
| Time (minutes) | Function Clarity (%) |
| 0 | 100 |
| 1 | 89.3 |
| 5 | 97.8 |
| 10 | 98.5 |
| 15 | 98.8 |
| 20 | 99.1 |
| 25 | 99.1 |
| 30 | 99.1 |

### Example 5

### Preparation of Coating Composition

A solution S-5-1 was prepared with 17 wt % of prepolymer-3, 46.8 wt % water, 30.3 wt %1-methoxy-2-propanol, 5.2 wt % propylene glycol, 0.02 wt % polyether siloxane copolymer, and 0.12 wt % bis (2,2,6,6-tetramethyl-4-piperidyl) sebacate. A solution S-8-2 was prepared consisting of 10 wt % polyoxypropylenediamine and 90 wt % water. A solution S-5-3 was prepared with 6 wt % polyoxypropylenediamine and 93% ethanol and 1% polyether siloxane copolymer. A solution S-5-4 was prepared with 8.5% sorbitol polyglycidyl ether, 15% (3-glycidyloxypropyl) trimethoxy silane, and 77.5% ethanol.

### Application of the Coating Composition on a Substrate

Equal volumes of S-5-3 and S-5-4 were combined, sprayed onto a glass slide, and baked at 130° C. for 10 minutes. Then, 0.53 g of solution S-5-1 was combined with 0.05 g of S-5-2, sprayed onto the slide, and baked at 130° C. for 10 minutes.

### Haze Value Measurement

The haze value of the glass slide with the coatings were measured as 0.2%. The steam test gave a Δ Haze of 0.3%.

### Soaking Study

The glass slide was soaked for 24 hours in a solution of 0.1% dish soap in deionized water. After the sample was removed from the solution, it appeared clear and had a haze value of 0.6%. The steam test gave a Δ Haze of 0.8%.

### Example 6

### Preparation of Coating Composition

A solution S-6-1 was prepared with 11 wt % of prepolymer-1, 31 wt % water, 51 wt %1-methoxy-2-propanol, 6 wt % propylene glycol, 0.6 wt % aluminum nanoparticles, 0.02 wt % Byk 3760, and 0.05 wt % bis (2,2,6,6-tetramethyl-4-piperidyl) sebacate. A solution S-6-2 was prepared consisting of 20 wt % O,O′-bis(2-aminopropyl) polypropylene glycol-block-polyethylene glycol-block-polypropylene glycol and 80 wt % water.

### Application of the Coating Composition on a Substrate

A coating composition was prepared by mixing 4 g of S-6-1 with 0.1 g of S-6-2.

Coating was applied to a pretreated polycarbonate sheet with an 80 microns bar coater. The polycarbonate sheet was then baked at 130° C. for 10 minutes to form a coating on the polycarbonate sheet. The haze value of the polycarbonate sheet with the coating was measured as 0.7%.

### Example 7

### Preparation of Coating Composition

A solution S-7-1 was prepared with 11 wt % of prepolymer-1, 31 wt % water, 52 wt %1-methoxy-2-propanol, 6 wt % propylene glycol, 0.02 wt % Byk 3760, and 0.05 wt % bis (2,2,6,6-tetramethyl-4-piperidyl) sebacate. A solution S-7-2 consisting of 20 wt % O,O′-bis(2-aminopropyl) polypropylene glycol-block-polyethylene glycol-block-polypropylene glycol and 80 wt % water was prepared. A solution S-7-3 consisting of 7.5 wt % O,O′-bis(2-aminopropyl) polypropylene glycol-block-polyethylene glycol-block-polypropylene glycol, 0.3 wt % bis (2,2,6,6-tetramethyl-4-piperidyl) sebacate, 0.2 wt % wetting additive polyether siloxane copolymer, and 92 wt % ethanol was prepared. A solution S-7-4 consisting of 10 wt % sorbitol polyglycidyl ether, 5 wt % (3-glycidyloxypropyl) trimethoxy silane, and 85 wt % ethanol was prepared.

### Application of the Coating Composition on a Substrate

Then, solution S-7-3 and S-7-4 were mixed, and sprayed onto a glass slide, and baked for 10 minutes at 130° C. to form a first coating on the glass slide.

### Coating Thickness

The thickness of the first coating on the glass slide was measured as 0.5 microns. Then, the first and second solutions were mixed, and sprayed onto the glass slide, and baked for 10 minutes at 130° C. to form a second coating. The thickness of the glass slide with the second coating on top of the first coating was measured as 5 microns.

### Haze Value Measurement

The haze value of the glass slide with the coatings was measured as 1.0%. The steam test gave a Δ Haze of 0.7%.

### INDUSTRIAL APPLICABILITY

This present disclosure describes an anti-fog coating composition, a kit, and a coating comprising a prepolymer and an amine bearing crosslinker. The present disclosure also describes a method of making the coating or a coated substrate using the composition or the kit. Such coatings may be applicable to a variety of industrial or consumer uses in which optical clarity is required and fogging is detrimental to the application. Non-limiting examples of such uses include coatings on automotive windows, camera lenses, sensors, such as lidar, radar, microwave, optical sensors, eye wear, including eyeglasses, visors, masks, goggles, shields and sunglasses, freezer windows, and mirrors, such as bathroom mirrors.

In addition, architectural designs that could benefit from the use of various embodiments disclosed herein include various glass and plastic products in different parts of a building, such as store-front displays and windows, greenhouses, cold storage food displays and freezer windows, shower doors, and glass enclosures around sporting events, such as ice hockey rinks.

Embodiments disclosed herein can be used to coat the camera attached to a scope used in a variety of medical applications. For example, endoscopes including gastroscopes, bronchoscopes, cystoscopes, ureteroscopy, arthroscope, as well as colonoscope, all could benefit from anti-fog characteristics associated with the disclosed invention.

The disclosed anti-fog coating herein can minimize one or more application difficulties. For example, the disclosed anti-fog coating composition, compound or kit do not contain highly toxic chemicals, are capable of curing at room temperature, can be applied on versatile types of substrates, and have a long pot life. The application method does not require expensive machinery, and process control equipment; and does not require complex, highly environmentally sensitive chemical reactions, which make the overall application easier and less expensive.

Other embodiments of the invention will be apparent to those skilled in the art from consideration of the specification and practice of the invention disclosed herein. It is intended that the specification and examples be considered as exemplary only, with the true scope of the invention being indicated by the following claims.

What is claimed is:

1. A composition for forming a crosslinked film that imparts anti-fog properties, the composition comprising:
at least one prepolymer comprising (a) one or more charged monomer residues; (b) one or more uncharged monomer residues; and (c) one or more amine reactive monomer residues; and
at least one amine bearing crosslinker,
wherein the crosslinked film has a change in haze value of less than 30% when exposed to fog conditions for a period longer than 30 seconds.

2. The composition of claim 1, wherein the composition is a two-component system comprising:
a first component comprising at least one prepolymer; and
a second component comprising at least one amine bearing crosslinker,
wherein the first component and the second component are found in said composition in an amount sufficient to form an anti-fog film having a change in haze values of less than 30% when exposed to fog conditions for a period longer than 30 seconds.

3. The composition of claim 2, wherein the composition comprises a molar ratio of the amine reactive monomer residues in the first component to the active hydrogens of the amines of the second component between 1 to 10 and 10 to 1.

4. The composition of claim 1, wherein the at least one prepolymer is composed of 0.01% to 30% by weight of charged monomer residues.

5. The composition of claim 1, wherein the at least one prepolymer is composed of 0.01% to 80% by weight of uncharged monomer residues.

6. The composition of claim 1, wherein the at least one prepolymer is composed of 0.01% to 30% by weight of amine reactive monomer residues.

7. The composition of claim 1, wherein the one or more charged monomer residues comprise sulfonate, carboxyl, phosphonate, nitro, imidazolium, guanidinium, or quaternary ammonium functional groups, or monomers that can be converted into those functional groups or combinations thereof,
wherein the one or more charged monomer residues comprising a sulfonate functional group comprise residues of 2-acrylamido-2-methylpropane sulfonic acid, 4-styrenesulfonate, vinyl sulfonic acid, 3-sulfopropyl acrylate, 3-sulfopropyl methacrylate, derivatives of these monomers, salts of these monomers, or combinations thereof,
wherein the one or more charged monomer residues comprising a carboxyl functional group comprise residues of acrylic acid, methacrylic acid, 2-carboxyethyl acrylate, p-styrene carboxylic acid, 3-acrylamido-3-methylbutanoic acid, maleic anhydride, itaconic acid, alginate methacrylate, derivatives of these monomers, salts of these monomers, or combinations thereof,
wherein the one or more charged monomer residues comprising a phosphonate functional group comprise residues of 11-phosphonoundecyl acrylate, vinylphosphonic acid, derivatives of these monomers, salts of these monomers, or combinations thereof,
wherein the one or more charged monomer residues comprising an imidazolium functional group comprise residues of 1-allyl-3-methylimidazolium chloride, 1-vinylimidazole, derivatives of these monomers, salts of these monomers, or combinations thereof, and
wherein the one or more charged monomer residues comprising a quaternary ammonium functional group comprise residues of [2-(methacryloyloxy)ethyl]dimethyl-(3-sulfopropyl)ammonium hydroxide, 2-ethyldimethylammonioethyl methacrylate, 2-(methacryloyloxy)ethyl] trimethylammonium, derivatives of these monomers, salts of these monomers, or combinations thereof.

8. The composition of claim 1, wherein the one or more, uncharged monomer residues are comprised of hydroxyl, pyrrolidone, acetate, or ether functional groups, or combinations thereof,
wherein the one or more uncharged monomer residues comprised of hydroxyl functional groups comprise residues of 2-hydroxyethyl methacrylate, hydroxypropyl methacrylate, N-(2-hydroxyethyl) methacrylamide, vinyl alcohol, the acrylate or methacrylate of a carbohydrate, derivatives of these monomers, or combinations thereof,
wherein the one or more uncharged monomer residues comprised of pyrrolidone functional groups comprise residues of n-vinyl-2-pyrrolidone, or derivatives of this monomer,
wherein the one or more uncharged monomer residues comprised of acetate functional groups comprise residues of vinyl acetate, diacetone acrylamide, derivatives of these monomers, or combinations thereof, and
wherein the one or more uncharged monomer residues comprised of ether functional groups comprise residues of tetrahydrofurfuryl acrylate or methacrylate, any acrylate or methacrylate-based monomer with a polyethylene glycol or polypropylene glycol functionality, 2-ethoxyethyl methacrylate, diethylene glycol butyl ether methacrylate, derivatives of these monomers, or combinations thereof.

9. The composition of claim 1, wherein the one or more amine reactive monomer residues are comprised of epoxy, ketone, anhydride, alkene, or isocyanate functional groups, or combinations thereof,
wherein the one or more amine reactive monomer residues comprised of epoxy functional groups comprise residues of glycidyl methacrylate, 3, 4-epoxycyclohexylmethyl methacrylate, allyl glycidyl ether, 4-vinyl-1-cyclohexene 1,2-epoxide, derivatives of these monomers, or combinations thereof, wherein the one or more amine reactive monomer residues comprised of ketone functional groups comprise residues of methyl vinyl ketone, diacetone acrylamide, derivatives of these monomers, or combinations thereof,
wherein the one or more amine reactive monomer residues comprised of anhydride functional groups comprise residues of n-hydroxy succinimide bearing monomers, maleic anhydride, derivatives of these monomers, or combinations thereof,
wherein the one or more amine reactive monomer residues comprised of alkene functional groups comprise residues of allyl methacrylate, vinyl methacrylate, derivatives of these monomers, or combinations thereof, and
wherein the one or more amine reactive monomer residues comprised of isocyanate functional groups comprise residues of 2-isocyanatoethyl methacrylate or derivatives thereof.

10. The composition of claim 1, wherein the amine bearing crosslinker comprises primary amines or secondary amines, or secondary amino silanes, or combinations thereof, wherein the amine bearing crosslinker comprises polyether amine, or a polymer with a polyether backbone comprising polyethylene oxide, polypropylene oxide, or other ethylene oxides that contains 1 or more nitrogen atoms per molecule, polyoxypropylenediamine, polyoxypropylenetriamine, O,O′-bis(2-aminopropyl) polypropylene glycol-block-polyethylene glycol-block-polypropylene glycol, n-butylaminopropyltrimethoxysilane, n-methylaminopropyltrimethoxysilane, bis(3-trimethoxysilylpropyl) amine, imidizoles, dicyandiamide, or combinations thereof.

11. The composition of claim 2, wherein the first component further comprises a carrier solvent comprising 20%-100% by weight of water, and 0%-80% by weight of one or more water miscible cosolvents, wherein the water miscible cosolvents comprise methanol, ethanol, isopropanol, 1-methoxy 2-propanol, acetone, methyl ethyl ketone, ethyl acetate, butanol, ethylene glycol, propylene glycol, glycerol or combinations thereof.

12. The composition of claim 2, wherein the second component further comprises a carrier solvent, wherein the carrier solvent comprises water, water miscible solvents comprising methanol, ethanol, isopropanol, 1-methoxy 2-propanol, acetone, methyl ethyl ketone, ethyl acetate, butanol, ethylene glycol, propylene glycol, glycerol or combinations thereof.

13. The composition of claim 1, further comprising one or more additives comprising a mechanical additive, a dispersant, a coupling agent, a UV absorber, a UV stabilizer, a surfactant or leveling additive, a curing catalyst, anti-freeze additives, dyes, or biocides.

14. The composition of claim 13, wherein the one or more additives are found in the composition in a concentration greater than 0.0001% and less than 40% by weight.

15. The composition of claim 13, wherein the mechanical additive comprises one or more of silica nanoparticles, alumina nanoparticles, zinc nanoparticles, ceria nanoparticles, titania nanoparticles, cellulose nanofibers, polyhedral oligomeric silsesquioxanes (POSS) materials, silsesquioxane materials, silicone materials, fumed silica, polyamide particles, phyllosilicate particles, montmorillonite particles, boehmite particles, epoxy-bearing reactive dilutants, waxes, or any combinations thereof.

16. The composition of claim 13, wherein the coupling agent comprises a molecule with a silane functional group and one or more epoxy, amine, thiol, anhydride, or isocyanate functional groups or combinations thereof, wherein the coupling agent comprises one or more of (3-aminopropyl)triethoxysilane, 2-(3,4-epoxycyclohexyl)ethyltriethoxysilane, (3-glycidoxypropyl)trimethoxysilane, 2-(3,4-epoxycyclohexyl)ethyltrimethoxysilane, (3-glycidoxypropyl)triethoxysilane, n-(2-aminoethyl)-3-aminopropyltrimethoxysilane, 3-mercaptopropyltrimethoxysilane, isocyanatopropyltriethoxysilane, n-methylaminopropyltrimethoxysilane, n-butylaminopropyltrimethoxysilane, bis(3-trimethoxysilylpropyl)amine, (3-triethoxysilyl)propylsuccinic anhydride, or combinations thereof.

17. The composition of claim 13, wherein the UV absorber comprises one or more of benzophenones, benzotriazoles, cyanoacrylates, hydroxyphenyl triazines, zinc nanoparticles, ceria nanoparticles, titania nanoparticles, or any combinations thereof.

18. The composition of claim 13, wherein the UV stabilizer comprises one or more hindered amine light stabilizer (HALS) agents, wherein said UV stabilizer comprises 2 bis (2,2,6,6-tetramethyl-4-piperidyl) sebacate, decanedioic acid, 1-methyl 10-(1,2,2,6,6-pentamethyl-4-piperidinyl), decanedioic acid, 1,10-bis(1,2,2,6,6-pentamethyl-4-piperidinyl)ester, dimethyl succinate polymer with 4-hydroxy-2,2,6,6-tetramethyl-1-piperidine ethanol, poly[[6-[(1,1,3,3,-tetramethylbutyl)amino-s-triazine-2,4-diyl] [2,2,6,6-tetramethyl-4-piperidyl)imino]]hexamethylene[(2,2,6,6-tetramethyl-4-piperidyl)imino]], or combinations thereof.

19. The composition of claim 13, wherein the surfactant or leveling agent comprises silicon polyether surfactants, polyethylene glycol p-(1,1,3,3-tetramethylbutyl)-phenyl ether, polysorbate based surfactants, sodium dodecyl sulfate, cetyltrimethylammonium bromide surfactants, dispersants, styrene-maleic acid copolymers, polyacrylates modified with silicones, polyethylene-polypropylene block copolymer surfactants, or combinations thereof.

20. The composition of claim 2, wherein the first composition and the second composition are found in an amount sufficient to have a pot life greater than 8 hours.

21. The composition of claim 2, wherein the first component and the second component are found in an amount sufficient to form a hydrophilic film that cures within 48 hours at 25° C. and 0%-50% relative humidity.

22. The composition of claim 2, wherein the first component and the second component are found in an amount sufficient to form a hydrophilic film that is dry to the touch after heating for 5 minutes at 130° C.

23. An anti-fog film comprising a crosslinked polymer, said crosslinked polymer comprising:
(a) one or more charged monomer residues;
(b) one or more uncharged monomer residues;
(c) one or more amine reactive monomer residues; and
(d) at least one amine bearing crosslinker residue,
wherein the anti-fog film exhibits a change in haze values of less than 30% when exposed to fog conditions for a period longer than 30 seconds.

24. A coated article comprising:
a substrate and a coating, said coating comprising a composition of:
a crosslinked polymer comprising:
(a) one or more charged monomer residues;
(b) one or more uncharged monomer residues;
(c) one or more amine reactive monomer residues; and
(d) at least one amine bearing crosslinker residue,
wherein the coated article exhibits a change in haze value of less than 30% when exposed to fog conditions for a period longer than 30 seconds.

25. A method of making a surface of a substrate resistant to fogging, said method comprising:
applying to the surface of the substrate a compound comprising:
a first composition comprising at least one prepolymer, the at least one prepolymer comprising (a) one or more charged monomer residues, (b) one or more uncharged monomer residues; and (c) one or more amine reactive monomer residues; and
a second composition comprising at least one amine bearing crosslinker, wherein the treated substrate exhibits a change in haze value of less than 30% when exposed to fog conditions for a period longer than 30 seconds.

26. A kit for forming a hydrophilic, crosslinked film comprising:
(A) a first component comprising a first composition comprising at least one prepolymer, the at least one prepolymer comprising (a) one or more charged monomer residues, (b) one or more uncharged monomer residues; and (c) one or more amine reactive monomer residues; and
(B) a second component comprising a second composition comprising at least one amine bearing crosslinker,
wherein the hydrophilic, crosslinked film exhibits a change in haze value of less than 30% when exposed to fog conditions for a period longer than 30 seconds.
